(19) United States
(12) Patent Application Publication
(10) Pub. No.: US 2012/0151101 A1
(43) Pub. Date: Jun. 14, 2012

(54) INTERFACE CONTROLLER, STORAGE DEVICE, AND TIMEOUT ADJUSTMENT METHOD

(75) Inventors: Kiyotaka MATSUO, Kokubunji-shi (JP); Nobuyuki Myouga, Ome-shi (JP); Hitoshi Hasegawa, Tachikawa-shi (JP)

(73) Assignee: Kabushiki Kaisha Toshiba, Tokyo (JP)

(21) Appl. No.: 13/294,897

(22) Filed: Nov. 11, 2011

(30) Foreign Application Priority Data
Dec. 14, 2010 (JP) 2010-278066

(51) Int. Cl. G06F 3/00

(52) U.S. Cl. 710/18

(57) ABSTRACT

According to one embodiment, an interface controller includes a first timer, a monitoring result obtaining module, a monitoring result buffer and an adjuster. The first timer measures elapsed time from a first time point when the interface controller is connected to a first host device of a plurality of host devices and detects a first timeout based on the measured elapsed time and a first timeout value. The monitoring result obtaining module obtains, as a monitoring result, a value indicative of the elapsed time measured at a second time point when a first frame is received from the first host device after the first time point and before the first timeout is detected. The monitoring result buffer stores the monitoring result obtained. The adjuster adjusts the first timeout value based on at least one monitoring result stored in the monitoring result buffer.

### CROSS-REFERENCE TO RELATED APPLICATIONS

This application is based upon and claims the benefit of priority from Japanese Patent Application No. 2010-278066, filed Dec. 14, 2010; the entire contents of which are incorporated herein by reference.

### FIELD

Embodiments described herein relate generally to an interface controller, a storage device, and a timeout adjustment method.

### BACKGROUND

Recent storage devices are generally each accessible from a plurality of host devices. A host device is hereinafter sometimes simply referred to as a host. To access a storage device, any one of a plurality of hosts (this host is hereinafter referred to as a first host) needs to establish a connection (more specifically, a logical connection) with the storage device. When a connection is established between the first host and the storage device, the first host can access the storage device to transfer, for example, data frames to the storage device. If the data to be transferred has a large size, the transfer of a data frame is repeated.

While the first host is repeatedly transferring a data frame to the storage device, another host (hereinafter referred to as the second host) cannot establish a connection with the storage device. That is, while the first host is occupying the connection with the storage device in order to transfer the data frames to the storage device, the second host cannot connect to the storage device.

Thus, the conventional storage device comprises a mechanism for preventing the first host from occupying the connection for a long time in order to transfer the data frames to the storage device (that is, in order to carry out data transfer). The mechanism sets, in the storage device, an upper limit on the time for which the first host occupies the connection with the storage device. This upper limit time is called a timeout period. When the timeout period elapses from when the first host starts transferring data to and from the storage device, the connection between the first host and the storage device is forcibly released (closed). This enables the second host to connect to the storage device.

However, when the set timeout period is excessively short, the above-described connection may be released while the first host is carrying out data transfer normally. Conversely, when the set timeout period is excessively long, the above-described connection may fail to be released for a long time even though the data transfer has failed, for example, in connection with the status of the first host.

Thus, techniques are conventionally proposed by which the timeout period used by the storage device to transfer data to and from the host (this timeout period is hereinafter referred to as the first timeout period) is automatically set. As one of such techniques, for example, a technique is known by which the first timeout period is updated based on an elapsed time from the start of the data transfer between the host and the storage device until a predetermined condition is established (this technique is hereinafter referred to as the conventional technique). The predetermined condition is, for example, detection of a timeout by the first host based on the timeout period set in the host (this timeout period is hereinafter referred to as the second timeout period).

According to the above-described conventional technique, the first timeout period corresponding to the second timeout period set in the host can be automatically set in the storage device. However, in the conventional technique, setting an effective first timeout period is difficult if the data transfer is not started even though a connection has been established between the host and the storage device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an exemplary configuration of a storage system comprising a storage device according to a first embodiment;

FIG. 2 is a block diagram showing an exemplary configuration of a SAS controller shown in FIG. 1;

FIG. 3 is a sequence chart illustrating a first example of operation according to the first embodiment;

FIG. 4 is a sequence chart illustrating a second example of operation according to the first embodiment;

FIG. 5 is a sequence chart illustrating a third example of operation according to the first embodiment;

FIG. 6 is a diagram illustrating a first timeout value adjustment method applied in the first embodiment;

FIG. 7 is a diagram illustrating a second timeout value adjustment method applied in a second embodiment;

FIG. 8 is a diagram illustrating the relationship between a sampling period and adjustment of a timeout value in a third timeout value adjustment method applied in a third embodiment;

FIG. 9 is a diagram illustrating the adjustment of the timeout value carried out after the sampling period according to the timeout value adjustment method; and

FIG. 10 is a diagram showing an example of a table in which timeout values corresponding to hosts are stored and which is applied to all of the first to third embodiments.

### DETAILED DESCRIPTION

Various embodiments will be described hereinafter with reference to the accompanying drawings. In general, according to one embodiment, there is provided an interface controller in a storage device accessible from a plurality of host devices via a interface bus. The interface controller comprises a first timer, a monitoring result obtaining module, a monitoring result buffer and an adjuster. The first timer is configured to measure elapsed time from a first time point when the interface controller is connected to a first host device of the plurality of host devices and to detect a first timeout based on the measured elapsed time and a first timeout value. The monitoring result obtaining module is configured to obtain, as a monitoring result, a value indicative of the elapsed time measured at a second time point when a first frame is received from the first host device after the first time point and before the first timeout is detected. The monitoring result buffer is configured to store the monitoring result obtained. The adjuster is configured to adjust the first timeout value based on at least one monitoring result stored in the monitoring result buffer.

### First Embodiment

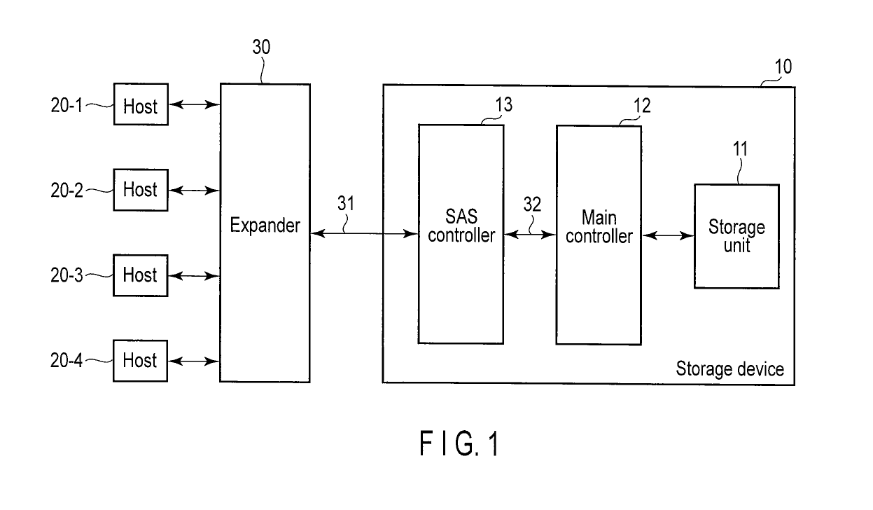

FIG. 1 is a block diagram showing an exemplary configuration of a storage system comprising a storage device according to a first embodiment. The storage system shown in FIG. 1 comprises a storage device 10 and a plurality of hosts, for example, four hosts 20-1, 20-2, 20-3, and 20-4. Each host 20-i (I=1, 2, 3, or 4) is, for example, a serial attached SCSI (SAS) host with a SAS interface. Each host 20-i is physically connected to the storage device 10 via an expander 30 and a SAS bus 31. In the first embodiment, a communication protocol compliant with the SCSI standard such as the serial SCSI protocol (SSP) or the serial management protocol (SMP) is used for communications made via the SAS bus 31 (that is, the communication protocol is a SCSI protocol in a broad sense).

The first embodiment involves two concepts of “connection”. A first concept of connection is a physical connection as described above. A second concept of connection is a connection for communication (that is, a logical connection). The host 20-i is not allowed to communicate with the storage device 10 simply by being physically connected to the storage device 10. The host 20-i cannot communicate with the storage device 10 until a logical connection is established between the host 20-i and the storage device 10. In the description below, the “logical connection” is simply referred to as the “connection”. That is, in the description below, simple description “connection” indicates a logical connection.

The storage device 10 is, for example, a SAS drive with a SAS interface. In the first embodiment, the storage device 10 is a SAS magnetic disk drive (HDD) or a solid-state drive (SSD). The storage device 10 comprises a storage unit 11, a main controller 12, and a SAS controller 13.

The storage unit 11 includes a magnetic disk as a storage medium if the storage device 10 is an HDD. The storage unit 11 includes a flash memory as a storage medium if the storage device 10 is an SDD. The main controller 12 controls data writes to the storage unit 11 or data reads from the storage unit 11. The main controller 12 is physically connected to the SAS controller 13 via an internal bus 32.

The SAS controller 13 is physically connected to the expander 30 via the SAS bus 31. The above-described four hosts 20-1 to 20-4 are physically connected to the expander 30. However, the number of hosts physically connected to the expander 30 need not be four. The SAS controller 13 controls connections with devices located outside the storage device 10 and including SAS interfaces. The SAS controller 13 may be replaced with an interface controller with an interface other than the SAS interface, for example, a serial ATA (SATA) interface or a SCSI interface.

For simplification of description, the number of external devices (initiators) that can be physically connected directly to the SAS controller 13 is assumed to be one (this number is hereinafter referred to as the allowable number of SAS controllers 13). That is, the SAS controller 13 is assumed to comprise one SAS port (initiator port). The expander 30 is used when the number of external devices to be physically connected to the storage device 10 exceeds the allowable number of SAS controllers 13. In the first embodiment, the four hosts 20-1 to 20-4 are physically connected to the expander 30 as described above. In this case, the expander 30 can physically connect the four hosts 20-1 to 20-4 to the storage device 10.

The host 20-i (i=1, 2, 3, or 4), one of the four hosts 20-1 to 20-4, can be (logically) connected to the storage device 10 under the control of the SAS controller 13. In this state, the host 20-i and the storage device 10 can communicate with each other, for example, transmit and receive data to and from each other. As described above, in the first embodiment, the number of hosts that can be connected to the storage device 10 is one, and a plurality of hosts cannot be simultaneously be connected to the storage device 10. Thus, if, for example, host 20-1 is connected to the storage device 10 and another host, for example host 20-2, requests a connection to the storage device 10, this connection request is rejected. In this case, host 20-2 needs to wait until the connection between host 20-1 and the storage device 10 is released (that is, closed).

It is assumed that at this time, host 20-1 is not transmitting or receiving any frames under a certain adverse effect. In this case, the SAS controller 13 adjusts the time for which host 20-1 occupies the connection. This enables an appropriate connection to be established in response to a connection request from host 20-2.

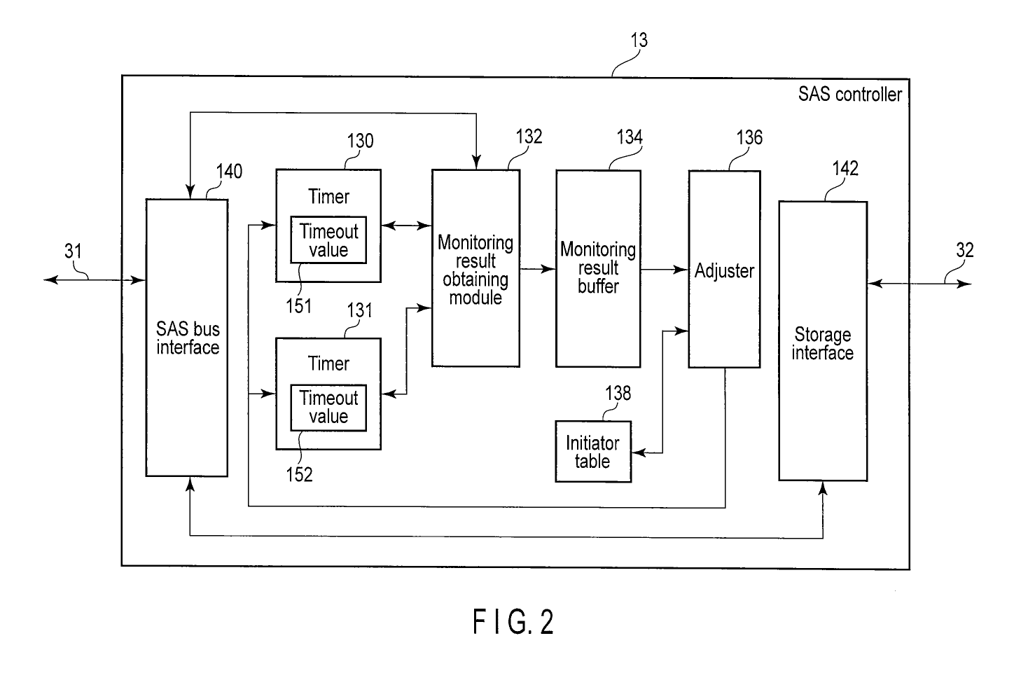

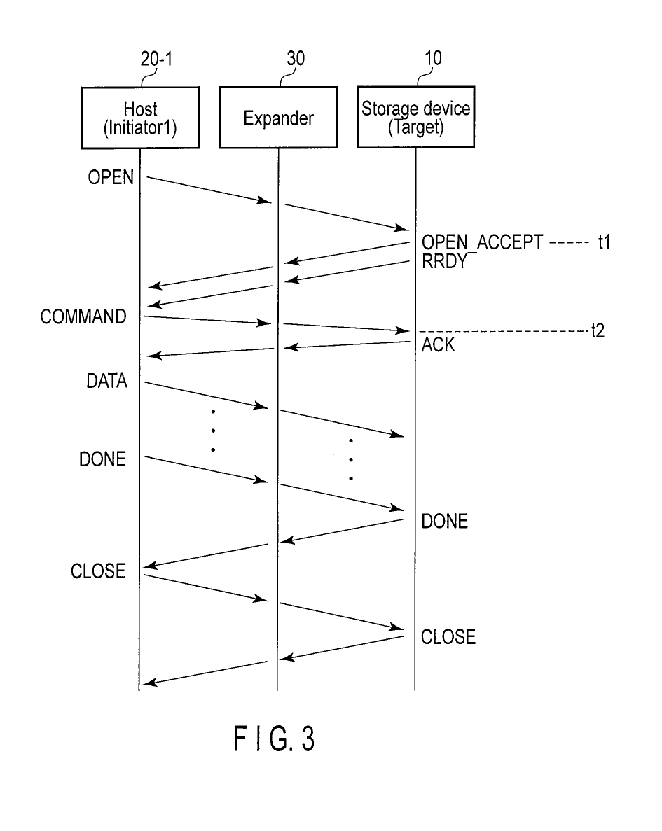

Now, the SAS controller 13 shown in FIG. 1 will be described in detail. FIG. 2 is a block diagram showing the configuration of the SAS controller 13. Before description of FIG. 2, an example of common handshaking (a first example of operation) will be described with reference to FIG. 3; for example, the handshaking is carried out after host 20-1 is connected to the storage device 10 and before the connection between host 20-1 and the storage device 10 is released.

FIG. 3 is a sequence chart illustrating a communication sequence (handshaking) from establishment of a connection until disconnection between host 20-1 (first host) serving as an initiator 1 and the storage device 10 serving as a target. The communication sequence includes transmission and reception of frames and primitives. In FIG. 3, host 20-1 (initiator 1) and the storage device 10 (target) transmit and receive frames and primitives via the expander 30.

First, it is assumed that in host 20-1 (initiator 1), the need to transmit a command frame (COMMAND) from host 20-1 to the storage device (target) 10 arises. Then, a connection (open) sequence for establishing the connection between host 20-1 and the storage device 10 is started as follows.

First, host 20-1 transmits an OPEN address frame as a connection request to the storage device 10. The storage device 10 receives the OPEN address frame transmitted by host 20-1, via the expander 30. Then, the storage device 10 responds to host 20-1 with an OPEN ACCEPT primitive as a primitive for connection acceptance when not connected to any other host. At this time point, a connection is established between host 20-1 and the storage device 10 (that is, the connection sequence is completed). This time point is defined as a first time point t1.

After the connection is established, the storage device 10 transmits a RRDY primitive to host 20-1. When the RRDY primitive is transmitted to host 20-1, host 20-1 can transmit the command frame. Thus, host 20-1 transmits the command frame (first frame) to the storage device 10. Upon receiving the command frame, the storage device 10 returns an ACK primitive to host 20-1. Then, host 20-1 starts transmitting data frames (DATA). A time point when the storage device 10 receives the first frame after the first time point t1 is defined as a second time point t2. It is assumed that some frames are subsequently transmitted and received between host 20-1 and the storage device 10. Then, host 20-1 and the storage device 10 shift to a disconnection (close) sequence for releasing (closing) the currently established connection.

First, host 20-1 transmits a DONE primitive to the storage device 10 in order to notify the storage device 10 that all of a series of frames have been transmitted. Then, as a response to the DONE primitive, the storage device 10 transmits a DONE primitive to host 20-1. That is, host 20-1 and the storage device 10 exchange the DONE primitives with each other. Similarly, host 20-1 and the storage device 10 exchange CLOSE primitives with each other. When the exchange of the CLOSE primitives is completed, the disconnection sequence is completed. Thus, the connection between host 20-1 (initiator 1) and the storage device 10 (target) is released (closed).

A host (for example, host 20-2) other than host 20-1 may make a connection request while a connection is maintained between host 20-1 and the storage device 10. In this case, host 20-2 needs to wait until the connection between host 20-1 and the storage device 10 is released. Furthermore, after a connection is established between host 20-1 and the storage device 10, possibly no frame is transmitted or received between host 20-1 and the storage device 10 unlike in the example illustrated in FIG. 3. In this case, in a configuration where a timeout is detected based on the time elapsing from the start of data transfer as in the conventional technique, achieving effective timeout detection is difficult. That is, host 20-2 needs to wait for a long time.

In the first embodiment, with the above-described case taken into account, if predetermined conditions are met, the currently established connection is forcibly released. Two predetermined conditions need to be met. A first condition is detection of a first timeout based on a timeout value (first timeout value) 151 (see FIG. 2). A second condition is detection of a second timeout based on a timeout value (second timeout value) 152 (see FIG. 2). Here, it should be noted that a time point serving as a starting point for detection of the first timeout and the second timeout is the first time point t1 as described above, unlike in the case of the conventional technique.

In the first embodiment, the timeout value 151 is set in a timer 130. Thus, even if no frame is transmitted or received between host 20-1 and the storage device 10, when the elapsed time from the first time point t1 exceeds the time indicated by the timeout value 151, the connection between host 20-1 and the storage device 10 is released. In the first embodiment, at least the timeout value 151, one of the timeout values 151 and 152, is adjusted by the SAS controller 13 of the storage device 10. Thus, the SAS controller 13 measures the time (elapsed time) from the first time point t1 to the second time point t2. The SAS controller 13 adjusts the timeout value 151 based on at least one measurement result.

With reference again to FIG. 2, the configuration of the SAS controller 13 with the function to adjust the timeout values as described above will be described. The SAS controller 13 comprises a SAS bus interface 140, a timer 130, a timer 131, a monitoring result obtaining module 132, a monitoring result buffer 134, an adjuster 136, an initiator table 138, and a storage interface 142.

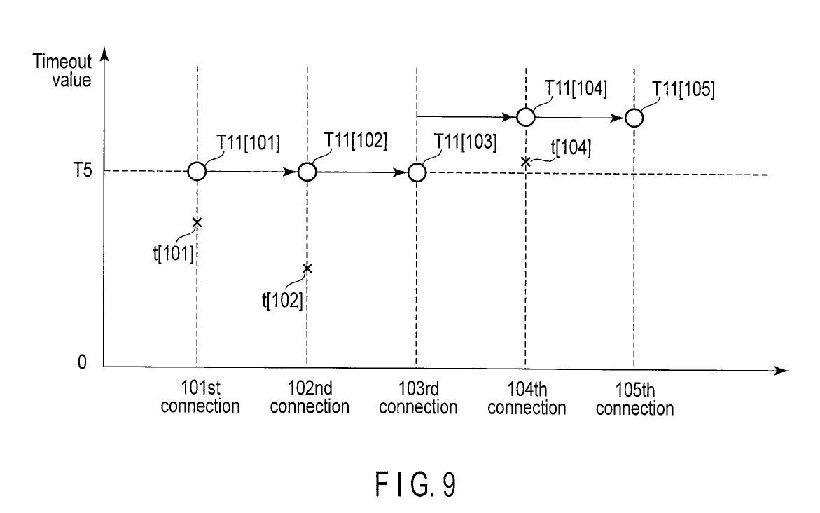

The timer 130 measures the elapsed time from the first time point t1 when a connection is established between the host 20-i (i=1, 2, 3, or 4) and the storage device 10. The host 20-i is one of hosts 20-1 to 20-4. The timeout value 151 is set in the timer 130. The timer 130 detects the first timeout when the measured elapsed time exceeds the time indicated by the timeout value 151 (first timeout period). Upon detecting the first timeout, the timer 130 clears the measured time. As the timeout value 151 set in the timer 130, a timeout value T1i[x] is used which corresponds to the host 20-i currently connected to the storage device 10. The timeout value T1i[x] is stored in the initiator table 138 in association with the host 20-i as described below with reference to FIG. 9.

The timer 131 measures the elapsed time from the first time point t1. The timeout value 152 is set in the timer 131. The timer 131 detects the second timeout when the measured elapsed time exceeds the time indicated by the timeout value 152 (second timeout period). Upon detecting the second timeout, the timer 131 clears the measured time. As the timeout value 152 set in the timer 131, a timeout value T2i[y] is used which corresponds to the host 20-i currently connected to the storage device 10. The timeout value T2i[y] is stored in the initiator table 138 in association with the host 20-i as described below with reference to FIG. 9.

The monitoring result obtaining module 132 monitors the statuses of the SAS bus interface 140 and the timer 130. Specifically, the monitoring result obtaining module 132 monitors the status of the SAS bus interface 140 to detect that a connection has been established between the host 20-i and the storage device 10. The monitoring result obtaining module 132 also monitors the statuses of the SA bus interface 140 and the timer 130 to detect that the first frame has been received after the first time point t1 when the above-described connection is established and before the timer 130 detects a timeout. The monitoring result obtaining module 132 also obtains, as a monitoring result, the time measured by the timer 130 at the time point (that is, the second time point) t2 when the reception of the first frame is detected. The monitoring result obtaining module 132 stores the obtained monitoring result in the monitoring result buffer 134 in association with the host 20-i. The monitoring result obtaining module 132 further monitors detection of the first timeout by the timer 130 to allow the storage device 10 (more specifically, the SAS bus interface 140) to shift to the disconnection sequence.

The monitoring result buffer 134 stores the monitoring result obtained by the monitoring result buffer 132 for each host 20-i. If the host 20-i is connected to the storage device 10 a plurality of times, a plurality of monitoring results are stored in the monitoring result buffer 134 in association with the host 20-i.

The adjuster 136 adjusts the timeout value 151 based on at least one monitoring result stored in the monitoring result buffer 134 in association with the host 20-i. More specifically, the adjuster 136 adjusts the timeout value T1i[x] used as the timeout value 151. The timeout value T1i[x] is stored in the initiator table 138 in association with the host 20-i. A method for adjusting the timeout value 151 will be described below.

The adjuster 136 changes (updates) the timeout value T1i[x] stored in the initiator table 138 in association with the host 20-i, to the adjusted timeout value. The adjuster 136 also sets the timeout values T1i[x] and T2i[x] stored in the initiator table 138 in association with the host 20-i, in the timers 130 and 131 as the timeout values 151 and 152, respectively, every time the host 20-i is connected to the storage device 10.

The SAS bus interface 140 is physically connected to the expander 30 via the SAS bus 31. The SAS bus interface 140 transmits and receives frames and primitives to and from the host 20-I via the SAS bus 31 and the expander 30. The SAS bus interface 140 also functions as a disconnection module. That is, the SAS bus interface 140 releases the connection between the host 20-i and the storage device 10 when the timer 130 or the timer 131 detects a timeout with the host 20-i connected to the storage device 10.

The storage interface 142 is physically connected to the SAS bus interface 140. The storage interface 142 also physically connected to the main controller 12 in FIG. 1 via the internal bus 32. The storage interface 142 allows the data transfer between the SAS bus interface 140 and the main controller 12.

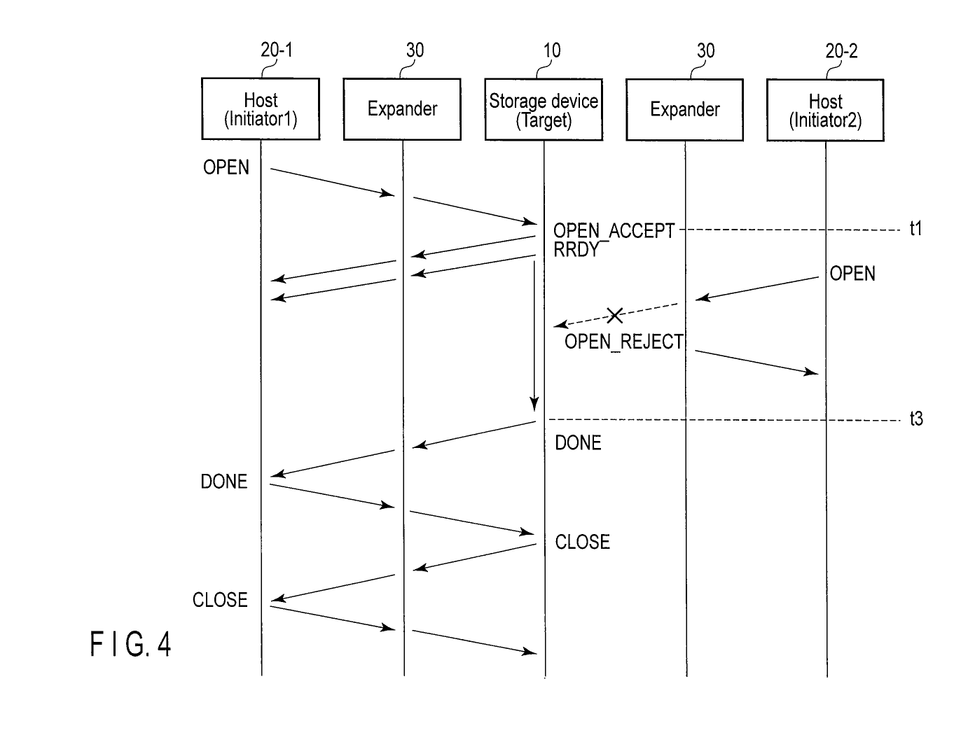

Now, a second example of operation according to the first embodiment will be described with reference to FIG. 4. Here, the host 20-i connected to the storage device 10 is assumed to be host 20-1. FIG. 4 is a sequence chart illustrating handshaking carried out after host 20-1 is connected to the storage device 10 and before the connection between host 20-1 and the storage device 10 is released, in the second example of operation according to the first embodiment.

The second example of operation illustrated in FIG. 4 is different from the first example of operation illustrated in FIG. 3. In the first example of operation, after the first time point t1 when a connection is established between host 20-1 (initiator 1) and the storage device 10 (target), host 20-1 immediately transmits a frame (in the example illustrated in FIG. 3, a command frame) to the storage device 10. In contrast, in the second example of operation, after the time point t1, host 20-1 (initiator 1) keeps putting off transmission of the first frame. In other words, host 20-1 (initiator 1) occupies the connection with the storage device 10 (target) even though host 20-1 is not transmitting any data to the storage device 10.

Moreover, in the example illustrated in FIG. 4, with host 20-1 and the storage device 10 connected together, a host different from host 20-1, for example, host 20-2 (initiator 2), makes a connection request to the storage device 10 before the timer 130 detects a first timeout. However, since host 20-1 occupies the connection, the connection request from host 20-2 is rejected.

It is assumed that the storage device 10 does not receive the first frame from host 20-1 and the timer 130 detects the first timeout at a third time point t3 shown in FIG. 4. In this case, the storage device 10 (more specifically, the SAS bus interface 140 of the SAS controller 13) shifts to the above-described disconnection sequence in order to forcibly release the connection with host 20-1. Thus, the storage device 10 transmits a DONE primitive to host 20-1. Then, in response to the DONE primitive, host 20-1 returns a DONE primitive to the storage device 10. Similarly, the storage device 10 and host 20-1 exchange CLOSE primitives with each other. This releases the connection between host 20-1 and the storage device 10.

Then, if for example, host 20-2 is in the connection wait state and is set in this connection wait state before the other host, host 20-2 can be connected to the storage device 10. However, if the first timeout value used to detect the first timeout has not been adjusted, host 20-1 may have occupied the connection with the storage device 10 for an extra time. That is, host 20-2 has been waiting for an extra time until host 20-2 can be connected to the storage device 10.

Thus, in the first embodiment, the storage device 10 (more specifically, the adjuster 136 of the SAS controller 13) adjusts the first timeout value associated with host 20-1, as described below. That is, the storage device 10 sets a first timeout value suitable for host 20-1. Hence, in such a situation as illustrated in FIG. 4, host 20-1 can be prevented from occupying the connection for a wasted time.

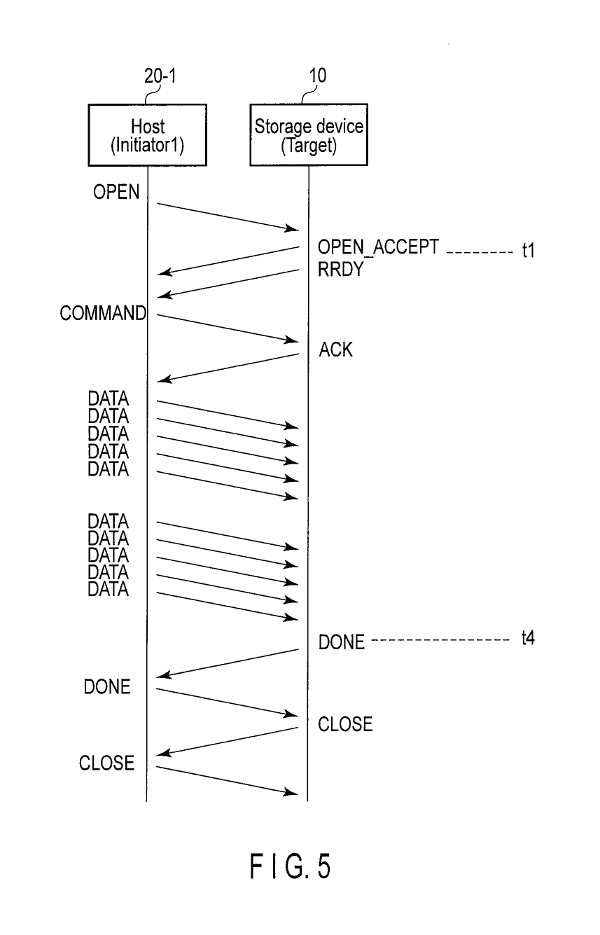

Now, a third example of operation according to the first embodiment will be described with reference to FIG. 5. Operations similar to those in the second example of operation illustrated in FIG. 4 will not be described below. FIG. 5 is a sequence chart illustrating handshaking carried out after host 20-1 is connected to the storage device 10 and before the connection between host 20-1 and the storage device 10 is released, in the third example of operation according to the first embodiment.

In the third example of operation illustrated in FIG. 5, unlike in the case of the first example of operation illustrated in FIG. 3, host 20-1 repeatedly transmits data frames. It is assumed that even though the not all of a series of data frames have been transmitted, the timer detects the second timeout at a fourth time point t4 shown in FIG. 5. This state occurs when host 20-1 transmits a very large volume of frames or when a communication speed decreases. In this case, the storage device 10 (more specifically, the SAS bus interface 140 of the SAS controller 13) shifts to the above-described disconnection sequence in order to forcibly release the connection with host 20-1.

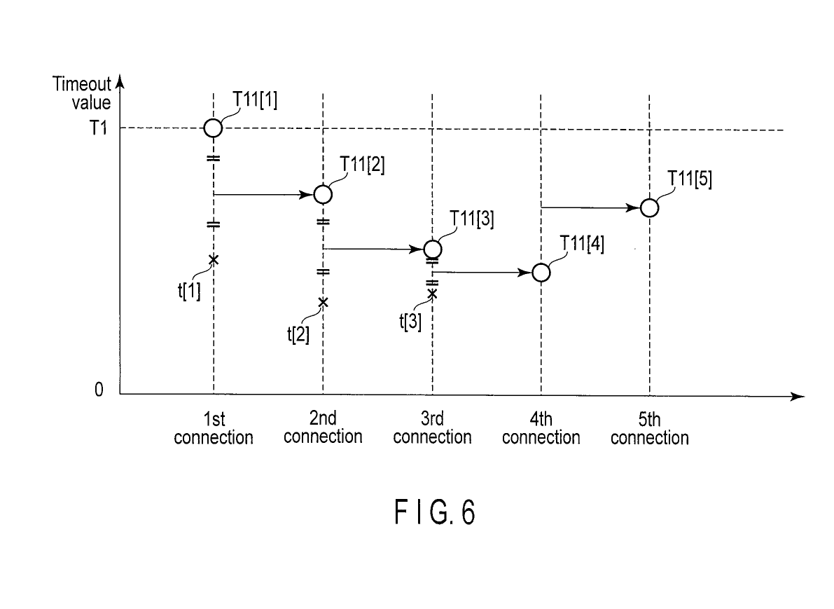

Now, a first timeout value adjustment method applied in the first embodiment will be described with reference to FIG. 6. FIG. 6 illustrates an example of the first timeout value adjustment method (hereinafter referred to as the averaging method) applied in the first embodiment and by which a timeout value T11[n−1] (n=2, 3, 4, . . . ) corresponding to host 20-1 and stored in the initiator table 138 is adjusted to a timeout value T11[n]. The timeout values T11[n−1] and T11[n] correspond to the above-described timeout value T1i[x]. Here, n−1 and n within brackets in the timeout values T11[n−1] and T11[n] denote the numbers of times that host 20-1 is connected to the storage device 10.

First, it is assumed that host 20-1 is connected to the storage device 10 and that the number of times that host 20-1 is connected to the storage device 10 becomes n-1. It is further assumed that at this time, the timeout value T11[n−1] is stored in the initiator table 138 in association with host 20-1. In this case, the adjuster 136 sets the timeout value T11[n−1] in the timer 130 as the timeout value 151. Setting of the timeout value in the timer 131 will be described below.

The timer 130 measures the elapsed time from the above-described first time point t1. The elapsed time t2-t1 measured between the first time point t1 and the second time point t2 by the timer 130 is denoted by t[n−1]. The time indicated by the timeout value T11[n−1] is denoted by T11[n−1]. The measured elapsed time t[n−1] is obtained by the monitoring result obtaining module 132 and stored in the monitoring result buffer 134 as described above.

The adjuster 136 calculates the time (average time) T11[n] corresponding to the average of the elapsed time t[n−1] obtained and the timeout value T11[n−1] in accordance with:

T11[n]=(T11[n−1]+t[n−1])/2 (n≧2)

In the averaging method, the value indicative of the average time T11[n] is used as a timeout value T11[n] for the next connection between host 20-1 and the storage device 10. Thus, the adjuster 136 updates the timeout value stored in the initiator table 138 in association with host 20-1, from T11[n−1] to T11[n]. The timeout value T11[n−1] where n is 2, that is, the timeout value T11[1] (T11[x]=T11[1]), is used for the first connection, and is, for example, 1 ms. The time T11[1] indicated by the timeout value T11[1] corresponds to T1 shown in FIG. 6.

Now, it is assumed that a timeout occurs in which the elapsed time t[n−1] exceeds the timeout value T11[n−1]. In this case, the adjuster 136 multiplies the timeout value T11[n−1] by a constant, for example, 1.2. The adjuster 136 determines the timeout value T11[n−1] multiplied by 1.2 to be the timeout value T11[n] for the next connection.

Specific description will be given with reference to FIG. 6. The description below is based on the assumption that host 20-1 is connected to the storage device 10. First, it is assumed that at the time of the first connection, a timeout has occurred. In this case, the adjuster 136 calculates the average T11[2] of T11[1]=T1 (=1 ms) and t[1]. The adjuster 136 updates T11[1] currently stored in the initiator table 138 to T11[2]. Thus, at the beginning of the second connection, T11[2] is set in the timer 130 as the timeout value 151. That is, the timeout value 151 is adjusted.

Then, it is assumed that at the time of the second and third connections, no timeout has occurred. In this case, as in the case of the first connection, the adjuster 136 calculates the average value to sequentially obtain T11[3] and T11[4] used for the third and fourth connections, respectively. Upon obtaining T11[3], the adjuster 136 updates the original T11[2] stored in the initiator table 138 to T11[3]. Thus, at the beginning of the third connection, T11[3] is set in the timer 130 as the timeout value 151. Furthermore, upon obtaining T11[4], the adjuster 136 updates the original T11[3] stored in the initiator table 138 to T11[4]. Thus, at the beginning of the fourth connection, T11[4] is set in the timer 130 as the timeout value 151.

At the time of the fourth connection, a timeout has occurred. Thus, as described above, T11[5] used for the fifth embodiment is determined to be T11[4] multiplied by a constant. For example, if the constant is 1.2, T11[5]=T11[4]×1.2. In FIG. 6, the number of times that host 20-1 is connected to the storage device 10 is not limited to five. Furthermore, T11[1]=T1 used for the first connection is not limited to 1 ms.

According to the first embodiment in which the above-described timeout value adjustment method (averaging method) is applied, repeated connections sequentially reduce the timeout value 151 set in the timer 130 as long as no timeout has occurred. Thus, if a timeout occurs, the time for which host 20-1 occupies the connection can be reduced.

### Second Embodiment

Now, a second embodiment will be described. Components and functions similar to those of the first embodiment will not be described below. In the second embodiment, a second timeout value adjustment method (addition and subtraction method) is applied. The second timeout value adjustment method (addition and subtraction method) is different from the first timeout value adjustment method (averaging method) applied in the first embodiment.

The addition and subtraction method applied in the second embodiment will be described below in brief. First, for example, it is assumed that host 20-1 is connected to the storage device 10 and that the number of times that host 20-1 is connected to the storage device 10 is n−1. It is also assumed that at the time of the n−1th connection, no timeout has occurred. That is, it is assumed that at the time point t2, the elapsed time measured by the timer 130 does not exceed the time indicated by the timeout value T11[n−1] set for the n−1th connection. In this case, the adjuster 136 applies the addition and subtraction method to subtract a specific value from the set timeout value T11[n−1]. Conversely, if a timeout occurs, the adjuster 136 adds the specific value to the timeout value T11[n−1]. In the addition and subtraction method, the value resulting from the subtraction or the addition is used as the timeout value T11[n] for the next, nth connection.

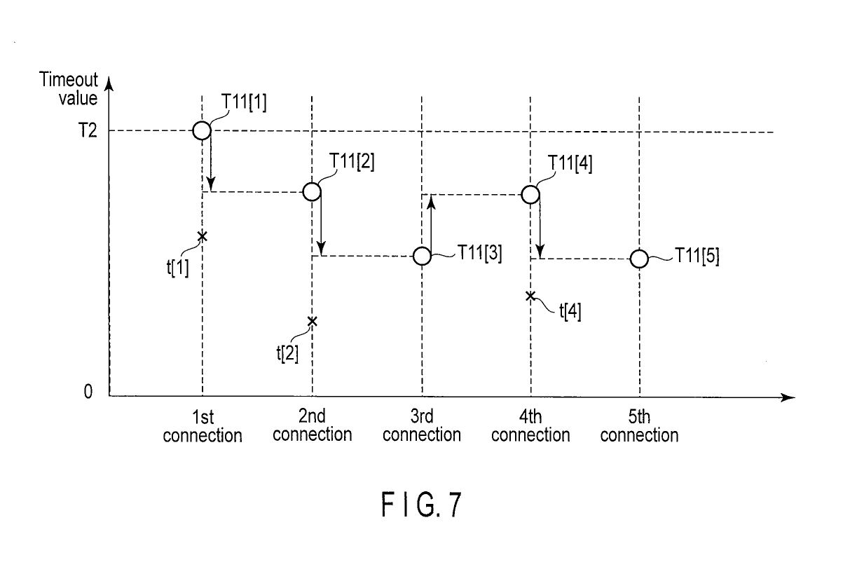

Now, a specific example of the addition and subtraction method applied in the second embodiment will be described with reference to FIG. 7. FIG. 7 is a diagram in a format similar to that of FIG. 6 and illustrates the addition and subtraction method. In an example illustrated in FIG. 7, at the time of the first connection, no timeout has occurred. Thus, as described above, the adjuster 136 subtracts the specific value from T11[1] to obtain T11[2]. The adjuster 136 then updates T11[1]=T2 (=1 ms) currently stored in the initiator table 138 to the calculated value T11[2]. Hence, at the beginning of the second connection, T11[2] is set in the timer 130 as the timeout value 151. That is, the timeout value 151 is adjusted.

Furthermore, at the time of the second connection, no timeout has occurred as is the case with the first connection. Thus, at the beginning of the third connection, as is the case with the first connection, the timeout value 151 is set to T11[3], which is equal to T11[2] minus the specific value.

At the time of the third connection, a timeout has occurred. Thus, as described above, the adjuster adds the specific value to T11[3] to obtain T11[4]. In this case, T11[3] stored in the initiator table 138 is updated to T11[4]. Hence, at the beginning of the fourth connection, the adjuster 130 sets T11[4] in the timer 130 as the timeout value 151.

In FIG. 7, the number of times that host 20-1 is connected to the storage device 10 is not limited to five. Furthermore, T11[1]=T2 used for the first connection is not limited to 1 ms. The specific value used for the above-described addition and subtraction method can be adjusted as required. Here, the specific value currently used is denoted by T. A value smaller than T may be used as the specific value in order to make the possibility of a timeout lower than the current value. This is because the smaller value enables a reduction in the amount of change in timeout value adjusted by the addition and subtraction. Conversely, even if the possibility of a timeout is higher than the current value, a value larger than T may be used as the specific value in order to reduce the time for which host 20-1 occupies the connection. This is because the larger value enables an increase in the amount of change in timeout value adjusted by the addition and subtraction.

As described above, according to the second embodiment in which the second timeout value adjustment method (addition and subtraction method) is applied, the timeout value can be adjusted by simple calculations. Furthermore, the timeout value can be effectively adjusted by appropriately changing the above-described specific value to a value corresponding to intended use.

### Third Embodiment

Now, a third embodiment will be described. Components and functions similar to those of the first embodiment will not be described. The third embodiment is characterized in that a third timeout value adjustment method (maximum value method) is used to adjust the timeout value. The maximum value method will be described below taking the connection between host 20-1 and the storage device 10 as an example.

In the maximum value method applied in the third embodiment, the timeout value is not adjusted until a predetermined plurality of connections are released. That is, before adjustment of the timeout value is started, the elapsed time t[n−1] from t1 to t2 (n=2, 3, 4, . . . ) is sampled as described above. Thus, a plurality of sampling results are obtained. The maximum value of the plurality of sampling results obtained is used as a timeout value for the connection following the predetermined plurality of connections. In the third embodiment, the predetermined plural number is 100. Furthermore, in the third embodiment, if a timeout occurs, the current timeout value is multiplied by a constant as is the case with the first embodiment.

It is assumed that unlike in the case of the third embodiment, after the first connection is released, the elapsed time sampled during the first connection is used as a timeout value for the next connection. In this case, if the elapsed time sampled during the first connection is short, a timeout is likely to occur during the second connection.

In contrast, in the third embodiment, the maximum value of the elapsed time sampled during each of a plurality of (100) connections is used as a timeout value for the next connection. Increasing the number of samples in this manner allows the maximum value of the plurality of sampling results to sufficiently indicate the tendency of the plurality of sampling results. That is, the maximum value of the plurality of sampling results sufficiently indicates the tendency of the elapsed time during the connection between host 20-1 and the storage device 10. Using the maximum value as the timeout value for the next connection enables a reduction in the possibility that a timeout occurs at the time of any of the subsequent connections (here, any of the 101st and subsequent connections).

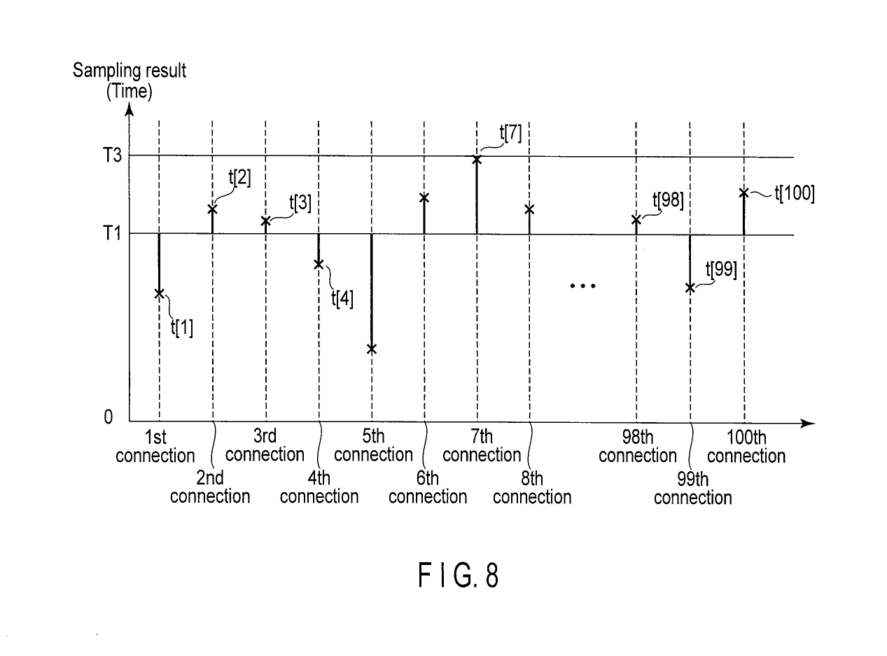

Now, a specific example of the maximum value method applied in the third embodiment will be described with reference to FIG. 8. FIG. 8 is a diagram showing the results of sampling of t[n−1] during each of the 100 connections between host 20-1 and the storage device 10. The sampling is carried out as follows. The timer 130 measures the elapsed time from t1 to t2 during each of the 100 connections between host 20-1 and the storage device 10. The measurement results are stored in the monitoring result buffer 134 as monitoring results. Based on the monitoring results, the adjuster 136 determines a timeout value to be used for the 101st connection.

In FIG. 8, t[1] to t[100] denotes the elapsed time measured by the timer 130. The adjuster 136 determines t[7]=T3, which is indicative of the maximum value of t[1] to t[100], to be the timeout value to be used for the 101st connection. Furthermore, the adjuster 136 may determine the average value T4 of t[1] to t[100] to be the timeout value to be used for the 101st connection. That is, the maximum value method involves two methods for determining, for example, the timeout value to be used for the 101st connection based on the 100 sampling results. A first method is to use the maximum value T3 of the 100 sampling values. A second method is to use the average value T4 of the 100 sampling values. As described above, in the third embodiment, the sampling period for the 100 connections is provided, and the timeout value to be used for the 101st connection is calculated.

Now, adjustment of the timeout value for the 101st and subsequent connections using calculated timeout value T3 or T4 will be described with reference to FIG. 9. FIG. 9 is a diagram in a format similar to that of FIGS. 6 and 7 and illustrates the adjustment the timeout value for the 101st to 105th connections between host 20-1 and the storage device 10. In FIG. 9, the above-described T3 or T4 is used as T5.

At the time of the 101st connection, no timeout has occurred. Thus, a timeout value T11[101]=T5 set at the beginning of the 101st connection is used as a timeout value T11[102] for the 102nd connection without any change. Also at the time of the 102nd connection, no timeout has occurred. Thus, the timeout value T11[102] set at the beginning of the 102nd connection is used as a timeout value T11[103] for the 103rd connection without any change.

At the time of the 103rd connection, a timeout has occurred. In this case, the adjuster 136 multiplies the timeout value T11[103] set at the beginning of the 103rd connection by a constant. The calculation result is then used as a timeout value T11[104] to be set at the beginning of the 104th connection. At the time of the 104th connection, no timeout has occurred. Thus, the adjuster 136 applies the timeout value T11[105] set at the beginning of the 104th connection as a timeout value T11[105] for use during the 105th connection, without any change. As described above, the third embodiment uses the maximum value method to adjust the timeout value.

In the maximum value method according to the third embodiment, the timeout value can be effectively adjusted by providing a sampling period covering a plurality of connections. For example, when the maximum value of the sampling results obtained from the 100 connections is set to be the timeout value for the 101st connection, the possibility of a timeout during the 101st and subsequent connections can be reduced. Furthermore, when the average value of the sampling results obtained from the 100 connections is set to be the timeout value for the 101st connection, if a timeout occurs during any of the 101st and subsequent connections, the time for which host 20-1 occupies the connection can be reduced.

Moreover, the constant used when a timeout occurs can be appropriately changed to a value corresponding to intended use. For example, an increase in the value of the constant enables a reduction in the possibility of a timeout during the connections following the one involving a timeout. Furthermore, a reduction in the value of the constant enables a decrease in the time for which the connection is occupied. That is, in the third embodiment, the constant is 1.3 but may have any other value. Additionally, the number of samplings corresponding to the sampling period may be plural and is not limited to 100.

In the third example of operation (see FIG. 5) according to the first embodiment, the connection between host 20-1 and the storage device 10 is released even though data frames to be transmitted to the storage device 10 remain in host 20-1. To minimize the possibility of such a phenomenon, the timeout value 152 can be adjusted as is the case with the adjustment of the timeout value 151 described above. That is, the monitoring result obtaining module 132 monitors the status of the timer 131 to obtain the elapsed time from the time point t1 to the time point t3, as a monitoring result. Based on at least one monitoring result obtained, the adjuster 136 adjusts the timeout value 152 to be used when host 20-1 is connected to the storage device 10. More specifically, the adjuster 136 adjusts a timeout value T21[y] stored in the initiator table 138 in association with host 20-1 and used as the timeout value 152. Using the adjusted timeout value T21[y] as the timeout value 152 enables the above-described connection to be released after host 20-1 transmits all of a series of data frames.

The method has been described which adjusts the timeout values T11[x] and T21[y] to be used by the timers 130 and 131 as the timeout values 151 and 152, respectively, when host 20-1 and the storage device 10 are connected together. This adjustment method is similarly applicable to the adjustment of the timeout value to be used for the connection between host 20-2, 20-3, or 20-4 and the storage device 10.

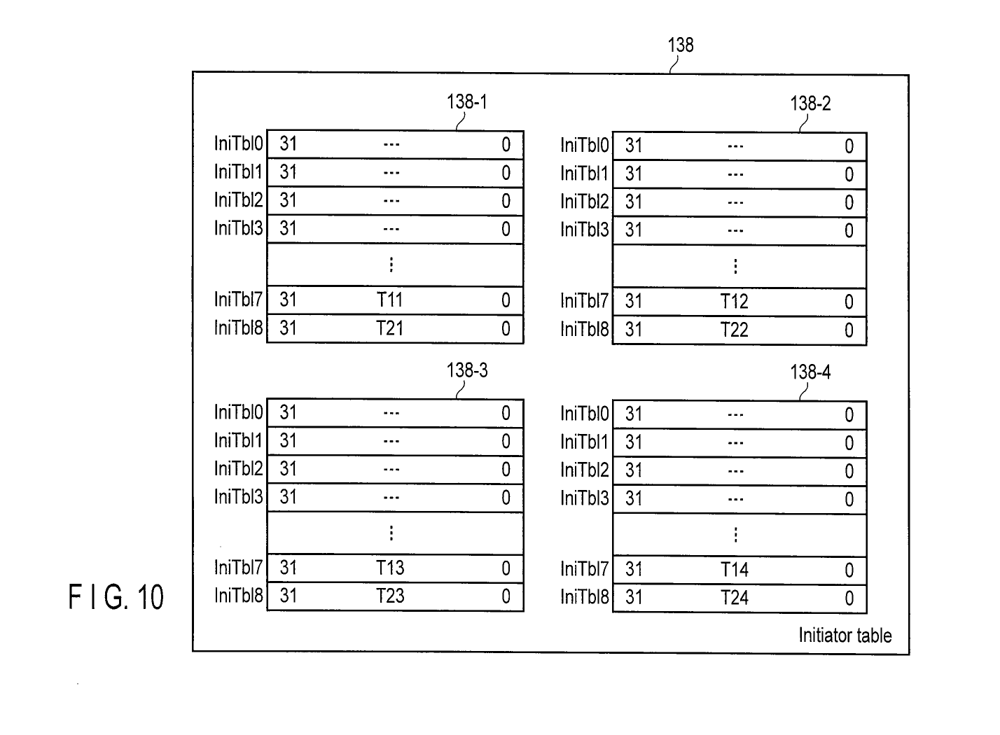

Finally, the initiator table 138 applied to all of the first to third embodiments will be described in detail with reference to FIG. 10. First, the above-described elapsed time from t1 to t2 and elapsed time from t1 to t3 are likely to vary among hosts 20-1 to 20-4. Thus, the above-described optimum timeout value varies among the hosts. Thus, timeout values may be stored for the respective hosts.

FIG. 10 is a diagram showing an example of the data structure of the initiator table 138. The initiator table 138 includes areas 138-1, 138-2, 138-3, and 138-4 corresponding to hosts 20-1, 20-2, 20-3, and 20-4 shown in FIG. 1. The area 138-1 corresponding to host 20-1 will be specifically described. The area 138-1 comprises a plurality of registers, for example, a zeroth register to an eighth register. Management information on host 20-1 is stored in the zeroth to eighth registers in the area 138-1. The management information includes, for example, a SAS address and two timeout values.

In the example illustrated in FIG. 10, timeout values T11 and T21 corresponding to the above-described timeout value T11[x] and T21[y] are stored in the seventh and eighth registers in the area 138-1 corresponding to host 20-1. When host 20-1 is connected to the storage device 10, the timeout values T11 and T21 stored in the seventh and eighth registers in the area 138-1 are set in the timers 130 and 131, respectively. This applies not only to the area 138-1 corresponding to host 20-1 but also to the areas 138-2 to 138-4 corresponding to hosts 20-2 to 20-4, respectively.

As described above, the two timeout values (more specifically, the two adjusted timeout values) corresponding to the host 21-i are stored in the area in the initiator table 138 corresponding to the host 20-i (i=1, 2, 3, or 4). Thus, every time the host 21-i is connected to the storage device 10, the two adjusted timeout values suitable for the host 21-i can be used in real time.

According to the first to third embodiments, the timeout value is adjusted based on the elapsed time from the time point t1 when the connection between the host and the storage device is established to the time point t2 when the first frame is received after the establishment of the connection. Thus, the timeout value can be adjusted so as to be suitable for the host. A timeout can be effectively generated even if the host does not transmit the first frame in spite of the established connection. Furthermore, according to the first to third embodiments, a timeout can be effectively generated if time is required to transmit data frames after the connection between the host and the storage device is established. At least one of the above-described embodiments can provide an interface controller, a storage device, and a timeout value setting method all of which enable a timeout to be effectively generated even if the host does not transmit the first frame in spite of the established connection.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An interface controller in a storage device accessible from a plurality of host devices via a interface bus, the interface controller comprising:
a first timer configured to measure elapsed time from a first time point when the interface controller is connected to a first host device of the plurality of host devices and to detect a first timeout based on the measured elapsed time and a first timeout value;
a monitoring result obtaining module configured to obtain, as a monitoring result, a value indicative of the elapsed time measured at a second time point when a first frame is received from the first host device after the first time point and before the first timeout is detected;
a monitoring result buffer configured to store the monitoring result obtained; and
an adjuster configured to adjust the first timeout value based on at least one monitoring result stored in the monitoring result buffer.

2. The interface controller of claim 1, wherein:
the at least one monitoring result is a plurality of monitoring results stored in the monitoring result buffer after a plurality of connections of the interface controller to the first host device is occurred; and
the adjuster is further configured to detect a tendency of the plurality of monitoring results based on the plurality of monitoring results and to adjust the first timeout value based on the detected tendency.

3. The interface controller of claim 2, wherein the adjuster is further configured to obtain a maximum value of the plurality of monitoring results as a value indicative of the detected tendency and to change the first timeout value to the maximum value obtained.

4. The interface controller of claim 2, wherein the adjuster is further configured to obtain an average value of the plurality of monitoring results as a value indicative of the detected tendency and to change the first timeout value to the average value obtained.

5. The interface controller of claim 1, wherein:
the at least one monitoring result is a latest monitoring result; and
the adjuster is further configured to calculate an average value of the first timeout value and the latest monitoring result and to change the first timeout value to the calculated average value.

6. The interface controller of claim 1, wherein:
the at least one monitoring result is a latest monitoring result; and
the adjuster is further configured to reduce the first timeout value by a predetermined value if the latest monitoring result is obtained.

7. The interface controller of claim 1, further comprising a storing module configured to store timeout values in association with the respective plurality of host devices,
wherein:
the first timer is further configured to use, as the first timeout value, the timeout value stored in the storing module in association with the first host device if the interface controller is connected to the first host device; and
the adjuster is further configured to adjust the timeout value stored in the storing module and used as the first timeout value.

8. The interface controller of claim 1, further comprising:
a second timer configured to measure the elapsed time from the first time point and to detect a second timeout based on the elapsed time measured by the second timer and a second timeout value larger than the first timeout value; and
a disconnection module configured to release the connection between the first host device and the interface controller in accordance with detection of the first timeout or the second timeout.

9. A storage device comprising:
a storage module; and
an interface controller configured to control a connection with a first host device of a plurality of host devices in accordance with a connection request transmitted by the first host device in order to allow the first host device to access the storage unit via a interface bus,
wherein the interface controller comprises:
a first timer configured to measure elapsed time from a first time point when the interface controller is connected to the first host device and to detect a first timeout based on the measured elapsed time and a first timeout value;
a monitoring result obtaining module configured to obtain, as a monitoring result, a value indicative of the elapsed time measured at a second time point when a first frame is received from the first host device after the first time point and before the first timeout is detected;
a monitoring result buffer configured to store the monitoring result obtained; and
an adjuster configured to adjust the first timeout value based on at least one monitoring result stored in the monitoring result buffer.

10. The storage device of claim 9, wherein:
the at least one monitoring result is a plurality of monitoring results stored in the monitoring result buffer after a plurality of connections of the interface controller to the first host device is occurred; and
the adjuster is further configured to detect a tendency of the plurality of monitoring results based on the plurality of monitoring results and to adjust the first timeout value based on the detected tendency.

11. The storage device of claim 10, wherein the adjuster is further configured to obtain a maximum value of the plurality of monitoring results as a value indicative of the detected tendency and to change the first timeout value to the maximum value obtained.

12. The storage device of claim 10, wherein the adjuster is further configured to obtain an average value of the plurality of monitoring results as a value indicative of the detected tendency and to change the first timeout value to the average value obtained.

13. The storage device of claim 9, wherein:
the interface controller further comprises a storing module configured to store timeout values in association with the respective plurality of host devices; and wherein
the first timer is further configured to use, as the first timeout value, the timeout value stored in the storing module in association with the first host device if the interface controller is connected to the first host device; and
the adjuster is further configured to adjust the timeout value stored in the storing module and used as the first timeout value.

14. The storage device of claim 9, wherein the interface controller further comprises:
a second timer configured to measure the elapsed time from the first time point and to detect a second timeout based on the elapsed time measured by the second timer and a second timeout value larger than the first timeout value; and
a disconnection module configured to release the connection between the first host device and the interface controller in accordance with detection of the first timeout or the second timeout.

15. A method for adjusting a timeout value in a storage device accessible from a plurality of host devices via a interface bus, the method comprising:
measuring elapsed time from a first time point when the storage device and a first host device of the plurality of host devices are connected together;
detecting a first timeout if a first frame is not received from the first host device before a time indicated by the first timeout value elapses from the first time point;
obtaining, as a monitoring result, a value indicative of the elapsed time measured at a second time point before the time indicated by the first timeout value elapses from the first time point if the first frame is received from the first host device at the second time point;
storing the obtained monitoring result in a monitoring result buffer; and
adjusting the first timeout value based on at least one monitoring result stored in the monitoring result buffer.

16. The method of claim 15, wherein:
the at least one monitoring result is a plurality of monitoring results stored in the monitoring result buffer after a plurality of connections of the storage device to the first host device is occurred;
the method further comprises detecting a tendency of the plurality of monitoring results based on the plurality of monitoring results; and
the first timeout value is adjusted based on the detected tendency.

17. The method of claim 16, further comprising:
obtaining a maximum value of the plurality of monitoring results as a value indicative of the detected tendency; and
changing the first timeout value to the maximum value obtained.

18. The method of claim 16, further comprising:
obtaining an average value of the plurality of monitoring results as a value indicative of the detected tendency; and
changing the first timeout value to the average value obtained.

19. The method of claim 15, wherein:
the storage device comprises a storing module configured to store timeout values in association with the respective plurality of host devices; and
the method further comprises:
using, as the first timeout value, the timeout value stored in the storing module in association with the first host device if the storage device is connected to the first host device; and
adjusting the timeout value stored in the storing module and used as the first timeout value.

20. The method of claim 15, further comprising:
detecting a second timeout based on the measured elapsed time and a second timeout value larger than the first timeout value; and
releasing the connection between the first host device and the storage device in accordance with detection of the first timeout or the second timeout.
